(19) United States
(12) Patent Application Publication
(10) Pub. No.: US 2024/0242461 A1
(43) Pub. Date: Jul. 18, 2024

(54) DATA DECODE

(71) Applicant: Hewlett-Packard Development Company, L.P., Spring, TX (US)

(72) Inventors: Matthew D GAUBATZ, Seattle, WA (US); Robert A ULICHNEY, Stow, MA (US); Stephen Bernard POLLARD, Bristol (GB)

(73) Assignee: Hewlett-Packard Development Company, L.P., Spring, TX (US)

(21) Appl. No.: 18/014,807

(22) PCT Filed: Jul. 6, 2020
(86) PCT No.: PCT/US2020/040923

§ 371 Date: Jan. 6, 2023

(51) Int. Cl. G06V 10/24; G06K 7/14

(52) U.S. Cl. CPC G06V 10/245; G06K 7/1443

(57) ABSTRACT

A system and method to decode data is disclosed. A process to decode data rendered as localized position features is applied. The process to decode includes stages. A feature location parameter is adjusted. A stage of the process is reapplied.

### BACKGROUND

Data-bearing media can include data-bearing structures and images, data-bearing magnetic media, data-bearing optical media, and other media. Examples of data-bearing images can include linear barcodes, matrix barcodes, and data rendered in images with localized position features such as data-bearing halftone images and visually significant barcodes. Data-bearing structures and images can convey digital information via selectively manipulating and then interpreting the positional features, such as halftone structures associated with a given carrier image. In one example, a halftone structure can encode data by perturbing positions of features such as halftone clusters in a halftoned image. The data can be interpreted by comparing the perturbed position of features, or shifted data-bearing features, on a medium to fiducials, or unshifted features included in the medium to localize the data-bearing features.

### BRIEF DESCRIPTION OF THE DRAWINGS

FIG. 1 is a block diagram illustrating an example method of decoding a payload on a data-bearing medium.

FIG. 2A is a schematic diagram illustrating an example of data-bearing medium that can be decoded via the example method of FIG. 1.

FIG. 2B is a schematic diagram illustrating a portion of the example data-bearing medium of FIG. 2A viewed as a planar surface.

FIG. 2C is a schematic diagram illustrating the portion of the data-bearing medium of FIG. 2B viewed as a curved surface.

FIG. 3 is a block diagram illustrating an example sub-method of the example method of decoding the payload of FIG. 1.

FIG. 4 is a flow diagram illustrating an example implementation of the example method of FIG. 1.

FIG. 5 is a flow diagram illustrating an example implementation of the example method of FIG. 4.

FIG. 6 is a schematic diagram of an example decoding system for recovering data from the example data-bearing medium of FIG. 2A such as via the example method of FIG. 1.

### DETAILED DESCRIPTION

Data-bearing features, such as visually significant barcodes, provide an effective mechanism to embed high capacity data in two-dimensional images or three-dimensional structures that can be more aesthetically pleasing than barcodes. Patterns of dots, halftones, or other structures can be used to represent data. In general, data can be rendered as localized position features on surfaces. A feature can include a detectable modification of a surface. In one example, a feature can include a region with a property that differs from the surrounding area; the feature may, for example, be an area printed with a differentiating color, such a red dot printed on a blue package, or may be a protrusion out of or indentation into a surface that differs from the local flatter surface geometry. A feature may be distinguishable from a background in order to serve as a practical mechanism for embedding data; the local differences between the feature and the background enable the positions of the features to be detected, and the relationships between these positions can be used to embed data across a substrate. For instance, a data-bearing image, which includes an example of a data-bearing features, can convey information in existing images on labels or pages as an alternative to additional barcodes. The information can be encoded in the halftone of a carrier image by selectively shifting halftone clusters, or repositioning the cluster, to carry bits of a digital payload. The small size and large number of cells in a printed carrier image can provide for information densities of over two-thousand bits per square inch. Features can be used to make up a cell that includes data in the form of a perturbed feature and may include a reference feature, or a fiducial. The fiducial can be used to localize the position of the perturbed feature, and data can be interpreted by detecting the position of the perturbed feature with respect to the fiducial. For instance, data readers can interpret the shifts of the halftone clusters in the image to reproduce the payload. Examples in this disclosure are described with reference to two dimensional images for illustration but can also extend to three-dimensional structures, such as three-dimensionally printed items with data and fiducials. A challenge addressed by this work is that of being able to determine how to separate features from the background accurately enough in order to correctly interpret the data represented by via positions of the features.

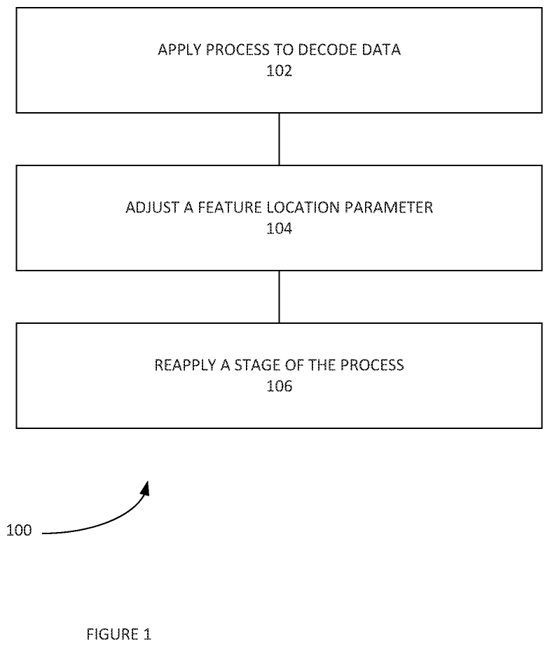

FIG. 1 illustrates an example of a method 100 to interpret data in a payload. A process to decode data rendered as localized position features is applied, such as to a data-bearing image or structure, at 102. In the example, the process to decode includes a plurality of stages. A feature location parameter is adjusted at 104. A stage of the plurality of stages of the process is reapplied at 106 to return the data.

In one example, method 100 provides a tiered analysis of the spatial representations of the data. For instance, the process to decode the data applied at 102 includes several stages, which may be explicit stages. A stage can include generating a list of the locations of the features. Another stage can include aligning the features to determine the perturbed or shifted features, which may include determining the shifted features from the fiducials. Still another stage can include mapping the perturbed features into data. A feature location parameter of the analysis is adjusted at 104. For example, the list generated with the locations of the features may be missing features or the position of a perturbed feature with respect to a fiducial may be indeterminate. In such a case, the adjustment at 104 can include a determination of the missing features, a refinement of the locations of the features, or re-registration of a portion or the entire image to boost the signal received from a data reader. Once an adjustment is made, a corresponding stage of the decoding process can be reapplied at 106. For example, if the image is to be re-registered, the entire decoding process may be repeated whereas if the adjustment is to refine the feature location, the final stage of the decoding process may be repeated.

One specific example implementation of method 100 includes inputting an image, applying the decoding process, and inputting a confidence threshold to be obtained. If the confidence threshold is not reached with the decoding process, a feature location parameter of the process is adjusted and a stage of the process is reapplied. The method in this implementation may be repeated until a confidence threshold is obtained, i.e., the degree of confidence in the applied process indicates a likelihood of success above a given threshold. Once the confidence threshold is reached, the data is returned.

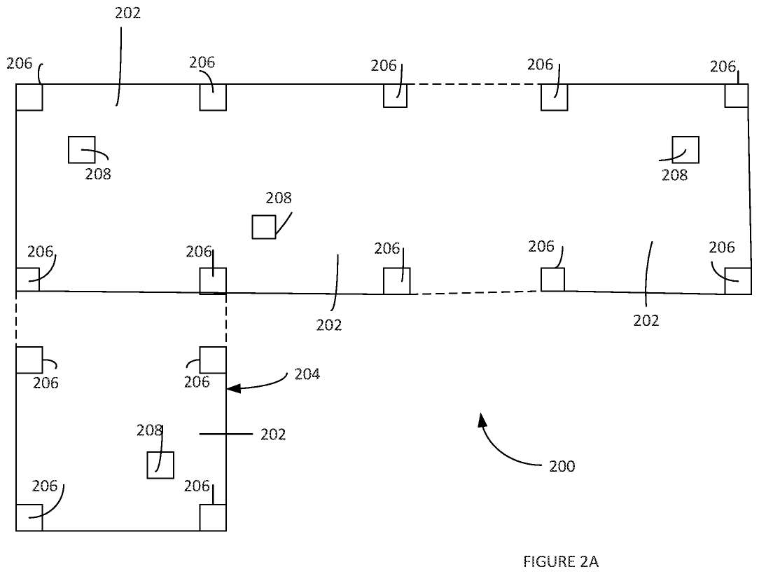

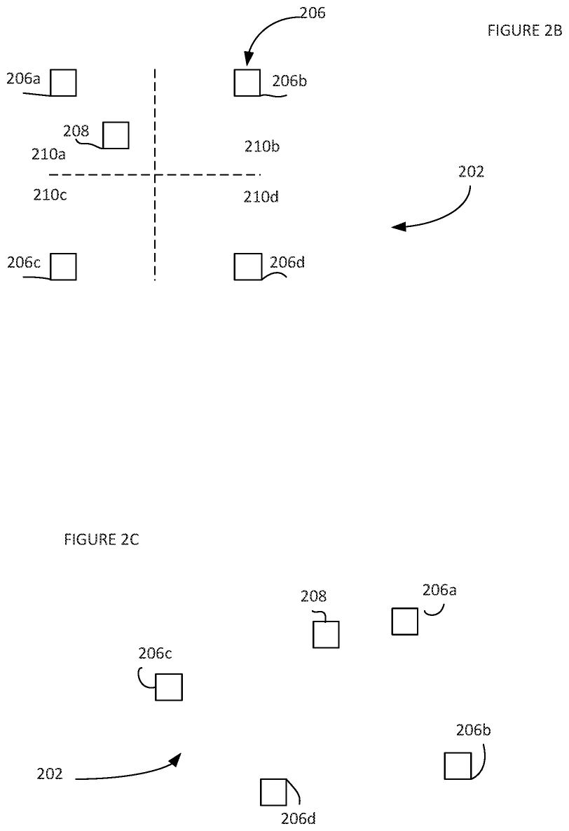

FIG. 2A illustrates an example data-bearing medium 200 having data rendered as localized position features. In one example, the data-bearing medium 200 can be generated via an encoding system including a printing device—such as a printer, copier, fax machine, multifunction device including additional scanning, copying, and finishing functions, all-in-one device, other device such as a pad printer to print images on three dimensional objects, or three-dimensional printer (additive manufacturing)—to receive a digital image or digital model and a medium, such as plain paper, photo paper, labels, and other media, to produce the data-bearing medium 200. In the example, the encoding system can receive a carrier, such as a carrier image or carrier model, and a payload to encode into the carrier such as via a data-bearing halftone image. In another example, the encoding system can receive a carrier model and a payload to encode into the surface of the carrier model such as via an arrangement of three-dimensional deformations of the surface.

The data-bearing medium 200 can include a region of a data-bearing image having a plurality of cells 202 arranged in an example two-dimension array 204 for illustration. The data-bearing medium 200 can include a payload encoded in a (typically much-larger) two-dimensional carrier image. The cells 202 can be included as part of a halftone of the carrier image. A cell used for illustration can include a matrix of i×j pixels; for example, an eight-by-eight cell can include sixty-four pixels. In the example, each cell 202 can be disposed between fiducials 206, which includes a pixel of a selected color in a multi-tonal combination of the carrier image. The array 204 includes a plurality of fiducials 206 that can define the boundaries of each cell 202 at predefined or expected positions on the data-bearing image such as in a grid-like pattern. A fiducial of more than one pixel can be a cluster pattern nucleated in a pixel group of a selected size. In the example, each cell 202 can include a data cluster 208, which includes a pixel of a selected color in the multi-tonal combination. A data cluster of more than one pixel can be a cluster pattern nucleated in a pixel group of various sizes. A cell having a data cluster size of one can include a pixel of a first color of a multi-tonal combination, such as black in a black/white color combination, and the remaining pixels are colored a second color of the multi-tonal color combination, such as white. In another example, each cell can be disposed between fiducials, which includes a pixel of a selected surface depth in a multi-depth relief rendering of the carrier. In this example, the pixels that are part of the surrounding regions and pixels that are part of the fiducials and data may be rendered at different depths, such as in a flat/raised combination.

Selected shifts of the data cluster 208 within the cell 202, such as with respect to the fiducials 206, have been used to carry data. A data cluster that can shift between two positions within a cell can carry one binary digit, or bit, of data. In a rudimentary example, a cell having a data cluster in a first position or shifted in a first direction with respect to the fiducials can carry a bit value of zero while a shifted version of the data cluster of the same size in a second position or shifted in a second direction with respect to the fiducials can carry a bit value of one. The array 204 in at least a portion of the data-bearing image 200 can thus carry a string of bits. This string of bits can be referred to as a raw payload, or a payload.

FIG. 2B illustrates a cell 202 from array 204 having a data cluster 208 positioned with respect to four fiducials 206, namely fiducials 206a, 206b, 206c, 206d. In some examples, a cluster can be mapped or positioned to several different pixel shift positions and can carry more than one bit of information. For example, each cell 202 may be conceptually separated into different portions or subregions within a cell, such as quadrants 210—each cell 202 can include an upper left or Northwest quadrant 210a, an upper right or Northeast quadrant 210b, a lower right or Southeast quadrant 210c, and a lower left or Southwest quadrant, 210d—of several pixels each. The data cluster 208, as illustrated, in the Northwest quadrant 210a may represent a two-bit value of 00, but a data cluster in the Northeast quadrant 210b may represent a two-bit value of 01, a data cluster in the Southwest quadrant 210c may represent a two-bit value of 10, and a data cluster in the Southeast quadrant 210d may represent a two-bit value of 11. Accordingly, the data in the cell can be rendered as a localized position feature, such as a cluster as determined by its respective quadrant with respect to the fiducials, and a payload, or portions of a payload, can be rendered as localized position features in a plurality of cells.

Systems that produce cluster-dot halftone images can selectively shift the data clusters within the cells with respect to the fiducials according to a selected payload when generating the data-bearing halftone image, and image readers that interpret the shifts within the cells can recover the payload.

The fiducial-based encoding scheme can be convenient when data is represented on or read from curved or three-dimensional surfaces. FIG. 2C illustrates the example planar cell 202 from FIG. 2B as represented on a three-dimensional surface. Although the quadrants 210 of the cell 202 do not appear as defined in the planar cell from FIG. 2B, the fiducials 206 can be used to locate the quadrant 210 to which the data cluster 208 belongs. Image readers that interpret the shifts within the cells may include sensitivity to spatially adaptive distortions, including lighting, focus, geometric surface properties, and local reflective behaviors, which can be addressed with method 100.

Fiducial-based encoding scheme can be used even when sets of fiducials 206 represent data via perturbations in positions of the features, as with the data clusters 208, i.e., when the fiducials 206 are also data clusters. In order to enable this capability, perturbations of data-clusters or the specification of the payload may be constrained, such that the payload can still be inferred from the relationships between the (perturbed) positions of the fiducials 206 and the positions of the data clusters 208. The features can include data clusters and fiducials.

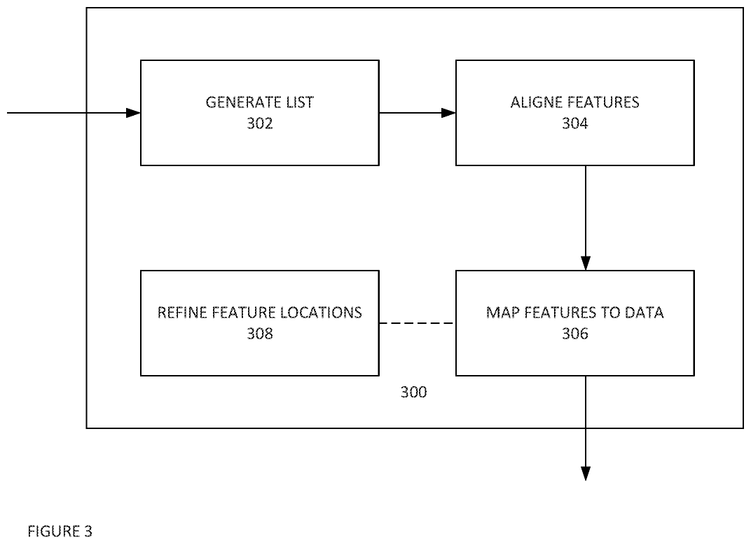

FIG. 3 illustrates an example process to decode data rendered as localized position features 300, or a decode process 300 implemented as a plurality of stages. In the example, a list of locations of the features is generated in a stage at 302, and the features are aligned to determine data features, such as a distinction is made from fiducial features, in a stage at 304. In some examples of a decode process, the stages 302, 304 can be combined. In some examples, a determination of whether a feature is a data feature or a fiducial feature is made by an estimation, and stage 304 can establish an ordering of the data features to be converted to data. In this example, the decode process 300 provides a list of feature locations that can be subsequently converted to data. The locations of the data features are mapped to data, such as via a location-based rule of the feature within a corresponding cell, in a stage at 306. For example, the location of the data feature can be mapped to a nearest region such as a subregion of a cell. Subsequently, the data can be returned if valid data is found, that is, this mapping can be successfully performed with a large enough number of data features.

Decode process 300 is illustrated in an example in which the features are colored pixels, or markings on a medium. The medium can be scanned with a data reader to generate an input image. The input image can be analyzed to determine a list of markings on the medium that includes fiducial markings and data markings. Once the markings are aligned at stage 304, the data markings can be determined as distinct from the fiducial markings. For example, the fiducial markings can appear at expected and regular locations, whereas the data markings can appear between the fiducial markings and at selectively irregular locations. In one example, a routine to determine locations of the markings can include difference-of-Gaussian filtering followed by detection of locations of local extrema. In an example that corresponds with FIGS. 2A-2C, the data markings can be ordered and mapped to the nearest quadrant in the corresponding cell and subsequently converted to data to determine the payload represented in the data bearing medium.

Other examples of the decode process can include other stages or additional stages. For example, the decode process 300 can include a refine feature location stage 308 that may be applied subsequent to aligning the markings at stage 304 and prior to mapping the data features to data at stage 306. In refining feature locations at 308, for example, the same routines that can be applied to determine the feature locations, the fiducial feature locations, or the data feature locations on the data-bearing medium can be reapplied on a more local scale, such as to selected portions of the data-bearing medium, or with augmented sensitivities, for a more precise determination of locations.

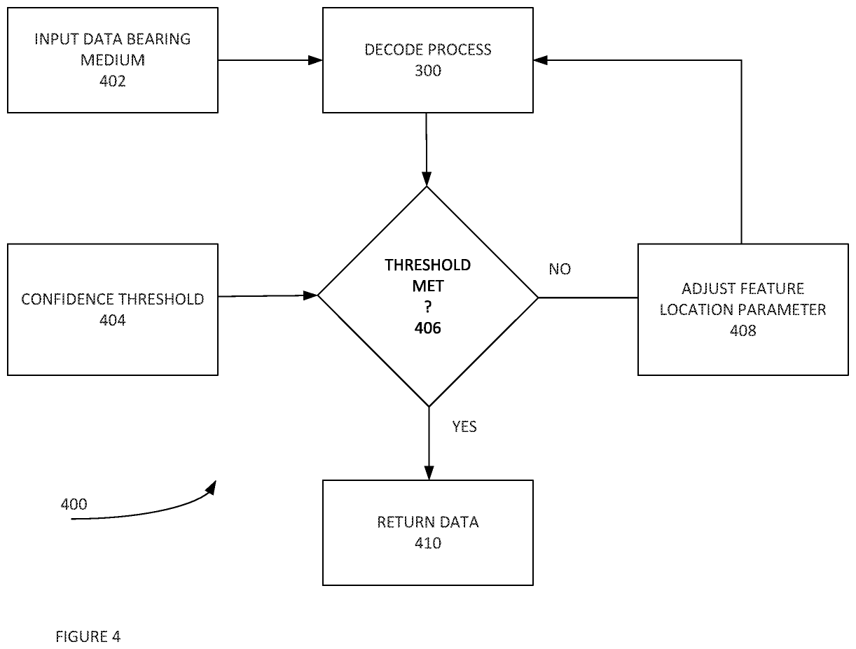

FIG. 4 illustrates an example method 400 that is an example implementation of method 100 and the decode process 300. An input of the data-bearing medium 402 is received. For example, an image of the data-bearing medium as taken from an imaging device such as a scanner or camera or from a data reader is received. Additionally, a confidence threshold 404 is provided. The confidence threshold can include a scalar value or a plurality of criteria that will become a threshold amount in the method 400. In some examples, the confidence threshold may be fixed or may vary based on the application, confidence obtained during various iterations of the decode process, or the payload to be recovered.

The decode process 300 is applied to the received input of the data-bearing medium. In the case where the input is an image of the data-bearing medium, such as an image generated from the data-bearing medium with an imaging feature of a data recovery system, the decode process 300 is applied to a processed and formatted image. In the example decode process 300, a list of locations of features is generated at 302 and aligned at 304. The locations can be mapped to data via a location-based rule at 306.

Rather than return data subsequent to the decode process 300, a determination is made as to whether the data generated with the decode process 300 has met a confidence threshold at 406. If, for example, the data generated with the decode process 300 has not met a confidence threshold at 406, a feature location parameter is adjusted at 408, and a stage such as 302, 304, 306 of the decode process 300 is performed again. For example, the decode process can be performed again starting from a stage, such as stages 302, 304, or 306 with the adjusted feature location parameter. A determination can be made again as to whether the data generated with the decode process has met the confidence threshold at 406. Once the data generated with the decode process 300 has met the confidence threshold, such as when it has surpassed the confidence threshold, at 406, data can be returned at 410.

The determination of whether the data generated with the decode process has met the confidence threshold at 406 can be made based on a number of factors. For instance, a confidence measurement can be taken from the alignment of features stage at 304 based on whether the detected features are in the expected locations. The confidence measurement can include an analysis of the decode process 300, such as a statistical determination of the likelihood of an accurate or precise mapping of the data feature locations to data. In one example, a high-quality signal of an image of a flat data-bearing medium may yield relatively small or tight point clouds of the data-bearing features at expected locations. A set of features that deviate from the expected locations can be used in a measurement of confidence of the data generated with the decode process, or confidence measurement. In the case of a high-quality signal on a flat surface, a great majority of the features are disposed in the expected locations of a data feature within a cell as defined by fiducials, such as in the location of a pixel in the cell. In such a case, the amount of deviations from the expected locations can be low, and thus the confidence measurement that the data generated with the decode process 300 is high. The confidence measurement can be applied against the input confidence threshold 404 at 406. In this case, the confidence measurement may meet the confidence threshold, and data is returned at 410. If, however, a signal of an image of the data bearing medium is subjected to spatially adaptive distortions such as poor lighting, ill focus, non-planar geometric properties, or reflection, a set of features that deviate from the expected locations, including features missing from the expected locations, can be high. In this case, the confidence measurement that the data generated with the decode process 300 is low. In this example, the confidence measurement applied against the input confidence threshold 404 at 406 may fail to meet the confidence threshold, and method 400 proceeds to adjust the feature location parameter at 408. Other mechanisms can be used to determine a confidence measurement of the data generated with the decode process, and the confidence measurement can be applied against the input confidence threshold 402 at 406.

Another mechanism to determine a confidence measurement of the data is based on assessment of the quality of the decoded payload. For example, the decoded payload can include redundant data serving the purpose of error detection or correction codes or other forms of protection against errors in the payload. In such coding schemes, assessing these codes can yield an estimate of the quality of the data. In cases where a coding scheme such as a cyclic redundancy check or Reed-Solomon code is used, interpreting the code generates an estimate of the errors present in the set of symbols in the payload. If the estimate of errors present is too high, a feature location parameter can be adjusted to improve the result. In other examples, data can be protected by repeating a sequence of symbols throughout a data-bearing medium, and the variation associated with symbols in the message can be determined on a per-symbol basis. If the quality of the symbols is assessed to be too low, feature location parameters can be adjusted in the locations corresponding to these symbols, and the decoding process reapplied, to improve the result.

Yet another mechanism for determining a confidence measurement can be based on the list of features generated at 302. If the number of features is not in an expected range, or the properties of the features (such as spacings between features, heights of the peaks of feature regions in filtered images, symmetry of the features, etc.) are not measured to be in expected ranges, feature location parameters can be adjusted in regions where these measurements are not consistent or among the least consistent with expected ranges, and the decoding process reapplied, to improve the result.

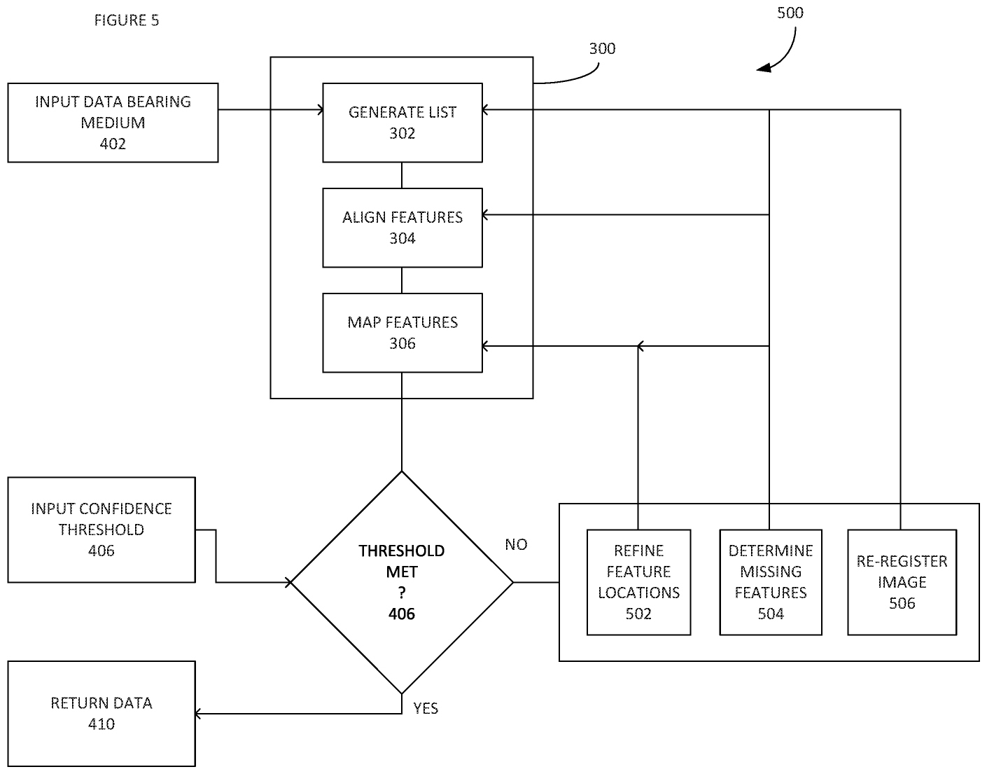

FIG. 5 illustrates an example method 500 that includes an example implementation of adjusting a feature location parameter at 408 if the confidence measurement does not meet the confidence threshold at 406. Examples of adjusting a feature location parameter 408 can include that a detected feature location is refined at 502, missing features are determined at 504, or the input is registered again to boost the signal at 506. An example of how a detected feature location can be refined at 502 includes reapplying the same routines that are used to determine the feature locations, the fiducial feature locations, or the data feature locations on the data-bearing medium on a more local scale, such as to selected portions of the data-bearing medium, for a more precise determination of locations. When an initial candidate list of features is generated at 302, the decode process may not have accurate information detailing to what extent a feature or the set of all features in an image of the data-bearing medium are discernible, i.e., the criteria used to determine the presence or absence of a feature may be approximate. Once an initial list of features is determined, the properties of features in the list provide a clearer notion of the expected degree to which features in the image are discernible. Consequently, it is possible to use the same stage that was used to generate the initial list, but to apply the stage where the criteria to determine if an element in the image of the data-bearing medium is a feature has been tuned to criteria appropriate for that particular image, or even for a particular region of that particular image; in this instance, the pixels designated as being associated with a given feature, even if it was present in the initial list, may be augmented, and in turn, the determined position of that feature can also be made more precise. The pixels associated with the list of candidate features can be determined by a number of steps, including finding locations of pixels associated with extreme values, that is, minima or maxima in the (difference-of-Gaussian-) filtered image, evaluating pixels based on contrast in a local neighborhood of a feature, normalizing the amplitude of the feature region, determining pixels where the curvature or otherwise local structure of the image satisfies symmetry conditions, etc. In such a case, for example, the feature may be detected in the process, but the location of the feature may be outside of an expected location such as a point cloud. The routine can be reapplied on a local scale of the input 402 to produce a more precise location of the feature. In one example, a larger set of the features determined in their expected locations can boost a confidence measurement. In one example, the alignment results from stage 304 can be applied to refine feature locations at 502. After the detected feature location is refined at 502, method 400 can, in one example, proceed to map the feature location to data at stage 306 of the decode process 300.

Another example of adjusting the feature location parameter 408 is that the missing feature are determined at 504. In one example, the alignment results from stage 304 can reveal any missing features from a list of locations of the features of stage 302. The regions of the input 402 can be revisited to extract additional features that are missing from the list of locations or the alignment of locations. Whereas the decode process 300 can improve detection performance with acquired knowledge characteristics of a given image, the decode process 300 can also use simpler principles to improve performance. If the structure or even simple count of features in a given location does not correspond to what is known about a region based on the detected surrounding features or other information determined from the image, the same feature interpretation process can be applied to make more targeted improvements in performance. For example, if it is known that features, such as fiducials, are expected appear in a checkerboard pattern, but only appear in arrangements of straight lines, the expected features are applied to refine the candidate list. In another example, if there are expected to be a certain number of features in a given neighborhood, and the number of features detected in that neighborhood is too low (or too high), the thresholds used to find the features can be adjusted accordingly. After the missing features are determined at 504, method 400 can, in one example, proceed either to map the feature locations to data at stage 306 of the decode process or to align results from stage 304 of the decode process.

Still another example of adjusting the feature location parameter 408 is the further processing of the input 402 such as to re-register the input to boost the signal at 506, that is, to increase the signal to noise ratio of the input. In some examples of the input being re-registered, the adjustment of feature location parameters 408 involves modifying the decoding process 300 used to analyze the input data or the ways in which the features derived from the input are interpreted to improve decoding performance. In another example of the input being re-registered, the image 402 that is passed into the process itself can be altered to improve decoding performance. Given an assessment of the decoding performance of the initial input image, it is possible to generate another input image that will enhance the performance of the respective stages in the decoding process 300. A benefit of operations applied to lists of features and associated feature locations is computational convenience; but more powerful augmentations of the decoding process 300 can be applied. A benefit of pixel-based enhancement of the input image is that no decisions regarding what regions contain features versus those that do not must be made, but rather, the image can be enhanced in a more continuous manner so as to provide the best opportunity for each successive stage to yield an improved result. In one example, the input image is re-registered such that determined feature locations appear closer to expected feature locations. As a result, the geometric artifacts resulting from curved or otherwise non-flat surfaces can have a reduced impact on feature list generation and the subsequent stages of the decoding process. After the input is re-registered at 506, method 400 can, in one example, proceed to generate a list of locations of the features at stage 302 of the decode process 300. In another example, the image is enhanced to increase the amplitude of artifacts that are of the expected size of features in the image. In yet another example, a denoising operator is applied to reduce interference from artifacts of the rendering that interfere with detection and interpretation of the desired features.

Method 400 can include one or more examples of adjusting the feature location parameter 408—such as refining the feature location 502, determining missing features 504, and re-registering the input 506—that can be performed alone or combination with another and cued sequentially in a selected order or based upon errors discovered in the decode process. For example, the decode process 300 may detect that the list of features is complete but that a set of the features may not be at expected locations, which could result in a low confidence measurement. In such a situation, the example of adjusting the feature location parameter 408 may be selected as refining the feature location at 502. In another example, the decode process 300 may detect that the list of features locations is incomplete, and the example of adjusting the feature location parameter 408 may be to determine missing features 504 or re-registering input 506. The decode process 300 can include a mechanism to gather statistics or measurements to determine which example of adjusting the feature location parameter to apply, which can be based on previous attempts to adjust the feature location parameter 408.

For instance, method 400 can select an example of adjusting the feature location parameter based on considerations including amount of additional processing or whether an example has been applied previously and did not result in a confidence measurement that met the confidence threshold. In one example, refining the feature location 502 may include less processing power than determining missing features 504, which may include less processing power than re-registering the input 506. If, the confidence threshold is not met upon the first application of the decode process 300 in method 400, the example of adjusting the feature location parameter may be to refine the feature location at 502. If, the confidence threshold is not met upon the application of the refinement of the feature locations at 502, the example of adjusting the feature location parameter may be to determine missing feature locations at 504. If, the confidence threshold is not met upon the application of the determination of missing feature locations at 504, the example of adjusting the feature location parameter may be to re-register the image to boost the signal at 506.

In another instance, method 400 can select an example of adjusting the feature location parameter based on considerations including the amount of the confidence measurement. For example, if the confidence measurement is relatively close to, but does not meet, the confidence threshold at 406, the feature location parameter adjustment can be an example that includes less processing power than other examples. If, for example, the confidence measurement is relatively far from, and does not meet, the confidence threshold at 406, the feature location parameter that is adjusted can be an example that includes greater processing power and more repeated stages of the decode process than other examples.

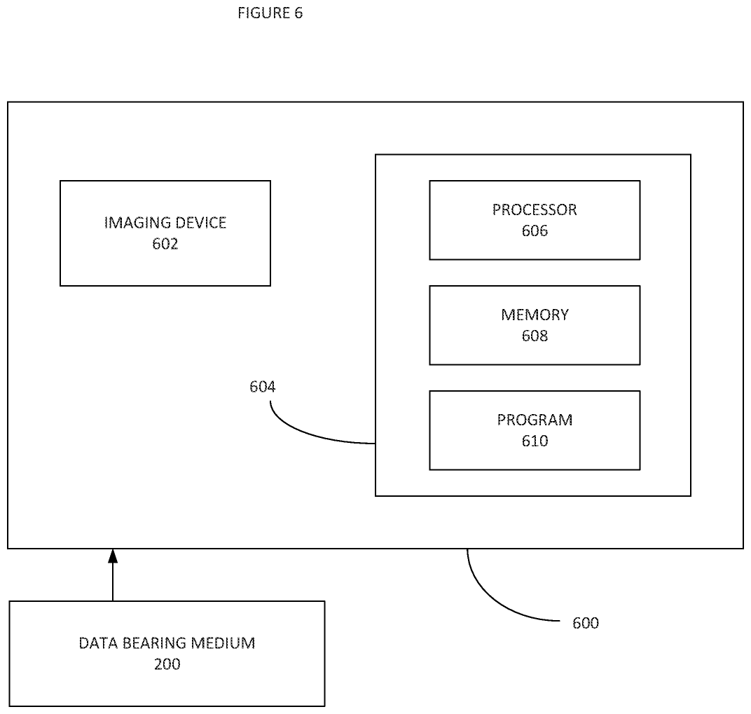

FIG. 6 illustrates an example data recovery system 600 that can be used to decode a data-bearing medium, such as data bearing medium 200. In the example, the data-bearing medium 200 includes a data-bearing halftone image. Example system 600 includes an imaging device 602 operably coupled to a computing system 604 having a processor 606 and memory 608 that are configured to implement an example method of this disclosure, such as methods 100, 400, 500 as a set of computer readable instructions stored in memory 608 for controlling the processor 606 to perform the method. In one example, the set of computer readable instructions can be implemented as a computer program 610 that can include various combinations of hardware and programming configured to operate on computing system 604. Computer program 610 can be stored in memory 608 and executed by the processor 606 to read the data-bearing image included on the data-bearing medium 200. In the example, the imaging device 602 and computing system 604 cooperate to read the data-bearing medium 200 and generate an input image, such as input 402. A confidence threshold 404 may be input via an input device (not shown) or retrieved from a storage (not shown). The data returned at 410 can be provided to a device for later retrieval or to an output device such as an output connection or a display. In one example, the system 600 is implemented as a data reader.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A method, comprising:
applying a process to decode data rendered as localized position features, the process to decode including a plurality of stages;
adjusting a feature location parameter; and
reapplying a stage of the process.

2. The method of claim 1 comprising returning data.

3. The method of claim 1 wherein the plurality of stages includes a stage to generate a list of location features, a stage to align the features to determine data features, and a stage to map data features to data.

4. The method of claim 3 wherein the reapplying a stage includes reapplying the stage to map data features to data.

5. The method of claim 3 wherein the plurality of stages includes a stage to refine locations of the features.

6. The method of claim 1 wherein the adjusting a feature location parameter is based on a confidence measurement of the process to decode data.

7. The method of claim 1 wherein the adjusting a feature location parameter includes refining locations of the features.

8. The method of claim 7 wherein the adjusting a feature location parameter includes determining missing features.

9. The method of claim 8 wherein the adjusting a feature location parameter includes registering the input to boost the signal.

10. A non-transitory computer readable medium to store computer executable instructions to control a processor to:
apply a process to decode data rendered as localized position features, the process to decode including a plurality of stages;
adjust a feature location parameter based on a confidence measurement of the decode process; and
reapply a stage of the process.

11. The non-transitory computer readable medium of claim 10 wherein the confidence measurement is applied against a confidence threshold.

12. The non-transitory computer readable medium of claim 10 wherein the adjustment of the feature location parameter includes one of refine locations of the features, determine missing features, and register the input to boost the signal.

13. A system, comprising:
a memory to store a set of instructions; and
a processor to execute the set of instructions to:
apply a process to decode data rendered as localized position features, the process to decode including a plurality of stages;
adjust a feature location parameter as determined from an analysis of the process to decode; and
reapply a stage of the process based on the adjusted feature location parameter.

14. The system of claim 13 including an imaging device to receive an input of the localized position features.

15. The system of claim 13 including a data reader.
